(19) United States
(12) Patent Application Publication
(10) Pub. No.: US 2025/0389566 A1
(43) Pub. Date: Dec. 25, 2025

(54) COOLING SYSTEM FLOW MONITORING

(71) Applicant: VERTIV CORPORATION, Westerville, OH (US)

(72) Inventor: ANDREW NATHAN COLE, Bellbrook, OH (US)

(73) Assignee: VERTIV CORPORATION, Westerville, OH (US)

(21) Appl. No.: 19/245,260

(22) Filed: Jun. 21, 2025

Related U.S. Application Data
(60) Provisional application No. 63/664,156, filed on Jun. 25, 2024.

(51) Int. Cl. G01F 1/60

(52) U.S. Cl. CPC G01F 1/60

(57) ABSTRACT

A flow indicator can include a housing, a sleeve disposed within the housing, a biasing device configured to bias the sleeve, a target coupled to the sleeve, and a sensor disposed in sensing communication with at least a portion of the sleeve. The biasing device can bias the sleeve towards an upstream end of the housing. The sensor can sense the presence and/or absence of the target at one or more sensing positions along the longitudinal axis of the housing. By sensing the presence, absence, or position of the target, the flow indicator can monitor flow characteristics and support flow diagnostics, such as compressor or pump health.

### CROSS REFERENCE TO RELATED APPLICATIONS

This application claims the benefit of U.S. Provisional Patent Application No. 63/664,156 filed Jun. 25, 2024, the entire contents of which are incorporated herein by reference.

### TECHNICAL FIELD

The present disclosure relates generally to monitoring cooling systems and more specifically relates to monitoring flow through cooling systems, such as to predict impending failure of one or more system components.

### BACKGROUND

Often, heating, ventilation and air conditioning (HVAC) systems are repaired only after a failure has already occurred. The result is long down times and/or being unprepared to make the repairs. One failure can cause others. A compressor or pump is often the primary component of many systems accounting for failure. Abnormalities in flow through compressors or pumps often precede the failure thereof. Thus, monitoring flow through compressors or pumps can help predict component failure and plan for preventative action.

### SUMMARY

Applicant has created new and useful devices, systems and methods for monitoring flow, such as through a compressed refrigerant loop. Embodiments of the disclosure can advantageously provide for improved maintenance and monitoring of the health of major cooling system components (e.g., compressors) without need for substantial increases in space requirements, electronics, or costs. For example, embodiments of the disclosure can be readily plumbed into existing plumbing, call for minimal maintenance, have minimal leak potential, and provide reliable, low-cost solutions for reducing redundancy of system components and supporting early failure prediction.

In at least one embodiment, a flow indicator according to the disclosure can include a housing, a sleeve disposed within the housing, a biasing device configured to bias the sleeve, a target coupled to the sleeve, a sensor disposed in sensing communication with at least a portion of the sleeve, or any combination thereof. In at least one embodiment, the housing can have an upstream end, a downstream end, and a longitudinal axis. In at least one embodiment, the sleeve can have an upstream end and a downstream end. In at least one embodiment, the biasing device can bias the sleeve towards the upstream end of the housing. In at least one embodiment, the sensor can sense the presence and/or absence of the target at one or more sensing positions along the longitudinal axis of the housing. In at least one embodiment, by sensing the presence and/or absence of the target, the flow indicator can sense the presence and/or absence of flow and/or one or more flow characteristics, such as through a compressor or pump and/or along a flow path of compressed or pumped fluid.

In at least one embodiment, the biasing device can be or include a spring disposed longitudinally between the downstream end of the sleeve and a shoulder on the downstream end of the housing. In at least one embodiment, the sensor can be or include a magnetic proximity sensor. In at least one embodiment, the target can be or include magnetic material. In at least one embodiment, the flow indicator can provide an indication of abnormal flow conditions when the sensor senses the presence, or absence, of the target. In at least one embodiment, the flow indicator can be, include, or operate as a switch. In at least one embodiment, the sensor can trigger an interruption of an electrical circuit when the sensor senses the presence, or absence, of the target.

In at least one embodiment, the sleeve can be or include a tubular body and/or can have one or more fins that extend radially inwardly from an interior surface, such as of the tubular body. In at least one embodiment, the tubular body can be cylindrical. In at least one embodiment, the tubular body can be tapered. In at least one embodiment, the interior surface of the tubular body can converge towards a central longitudinal axis of the sleeve in a direction from the upstream end of the sleeve to the downstream end of the sleeve. In at least one embodiment, the tubular body can have an outside dimension that increases in a direction from the upstream end of the sleeve to the downstream end of the sleeve for centering the sleeve within the housing when a fluid is flowing through the flow indicator. In at least one embodiment, the tubular body can have a rippled surface configured to resist fluid flow through the flow indicator.

In at least one embodiment, the one or more fins can be or include a plurality of fins, which can be equally spaced about a central longitudinal axis of the sleeve. In at least one embodiment, each of the plurality of fins can be a rectangular prism. In at least one embodiment, each of the plurality of fins can have a radially interior face that bounds a portion of a central flow path through the sleeve. In at least one embodiment, the radially interior face of each of the plurality of fins can be disposed at an angle relative to a central longitudinal axis of the sleeve. In at least one embodiment, the radially interior faces of the plurality of fins can converge towards the central longitudinal axis of the sleeve in a direction from the upstream end of the sleeve to the downstream end of the sleeve.

In at least one embodiment, the flow indicator can have one or more ramps disposed within the housing in sliding communication with the one or more fins. In at least one embodiment, the sleeve can have a default position relative to the one or more ramps. In at least one embodiment, the biasing device can bias the sleeve towards the default position with a biasing force. In at least one embodiment, the one or more ramps can cause the sleeve to rotate as the one or more fins slide along the one or more ramps when fluid flow through the flow indicator is sufficient to overcome the biasing force. In at least one embodiment, the one or more ramps can have a downstream terminal end. In at least one embodiment, the biasing device can return the sleeve to the default position when the one or more fins reach a slip position fluidically downstream of the downstream terminal ends of the ramps. In at least one embodiment, the sleeve can repeatedly complete a cycle back and forth among the default position and the slip position when fluid is flowing through the flow indicator. In at least one embodiment, the flow indicator can include a controller in electrical communication with the sensor. In at least one embodiment, the controller can determine a number of the cycles completed and/or a rate at which one or more of the cycles are completed.

### BRIEF DESCRIPTION OF THE DRAWINGS

FIG. 1 is a schematic diagram of one of many embodiments of a cooling system according to the disclosure.

FIG. 2 is a cross-sectional schematic diagram of one of many embodiments of a flow indicator according to the disclosure, showing a target in one position.

FIG. 3 is a cross-sectional schematic diagram of the flow indicator of FIG. 2, showing the target in another position.

FIG. 4 is a cross-sectional schematic diagram of another one of many embodiments of a flow indicator according to the disclosure.

FIG. 5 is a perspective view of one of many embodiments of a sleeve of a flow indicator according to the disclosure.

FIG. 6 is an end view of one of many embodiments of a sleeve of a flow indicator according to the disclosure.

FIG. 7 is an end view of another one of many embodiments of a sleeve of a flow indicator according to the disclosure.

### DETAILED DESCRIPTION

The figures described above and the written description of specific structures and functions below are not presented to limit the scope of what Applicant has invented or the scope of the appended claims. Rather, the figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specificdecisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms.

The use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the figures and are not intended to limit the scope of the inventions or the appended claims. The terms “including” and “such as” are illustrative and not limitative. The terms “couple,” “coupled,” “coupling,” “coupler,” and like terms are used broadly herein and can include any method or device for securing, binding, bonding, fastening, attaching, joining, inserting therein, forming thereon or therein, communicating, or otherwise associating, for example, mechanically, magnetically, electrically, chemically, operably, directly or indirectly with intermediate elements, one or more pieces of members together and can further include without limitation integrally forming one functional member with another in a unity fashion. The coupling can occur in any direction, including rotationally. Further, all parts and components of the disclosure that are capable of being physically embodied inherently include imaginary and real characteristics regardless of whether such characteristics are expressly described herein, including but not limited to characteristics such as axes, ends, inner and outer surfaces, interior spaces, tops, bottoms, sides, boundaries, dimensions (e.g., height, length, width, thickness), mass, weight, volume and density, among others.

Any process flowcharts or diagrams discussed herein illustrate the operation of possible implementations of systems, methods, and computer program products according to various embodiments of the present disclosure. In this regard, each block in a flowchart may represent a module, segment, or portion of code, which can comprise one or more executable instructions for implementing the specified logical function(s). It should also be noted that, in some implementations, the function(s) noted in the block(s) might occur out of the order depicted in the figures. For example, blocks shown in succession may, in fact, be executed substantially concurrently. It will also be noted that each block of flowchart or diagram can be implemented by special purpose hardware-based systems that perform the specified functions or acts, or combinations of special purpose hardware and computer instructions.

Applicant has created new and useful devices, systems and methods for monitoring flow through compressors or pumps, such as to track performance and/or predict failure thereof in order to take preventative action. Embodiments of the disclosure can advantageously provide for improved maintenance and monitoring of the health of major cooling system components (e.g., compressors) without need for substantial increases in space requirements, electronics, or costs. For example, embodiments of the disclosure can be readily plumbed into existing plumbing, call for minimal maintenance, have minimal leak potential, and provide reliable, low-cost solutions for reducing redundancy of system components and supporting early failure prediction.

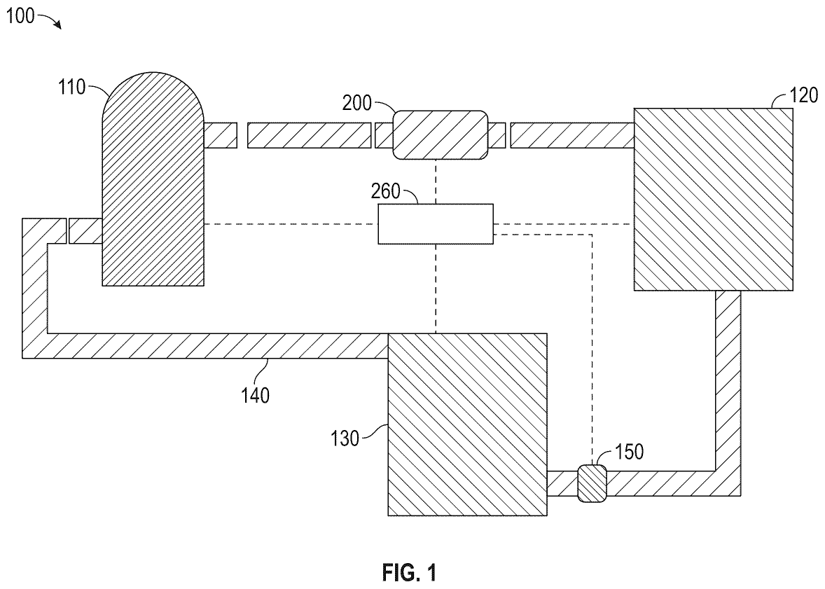

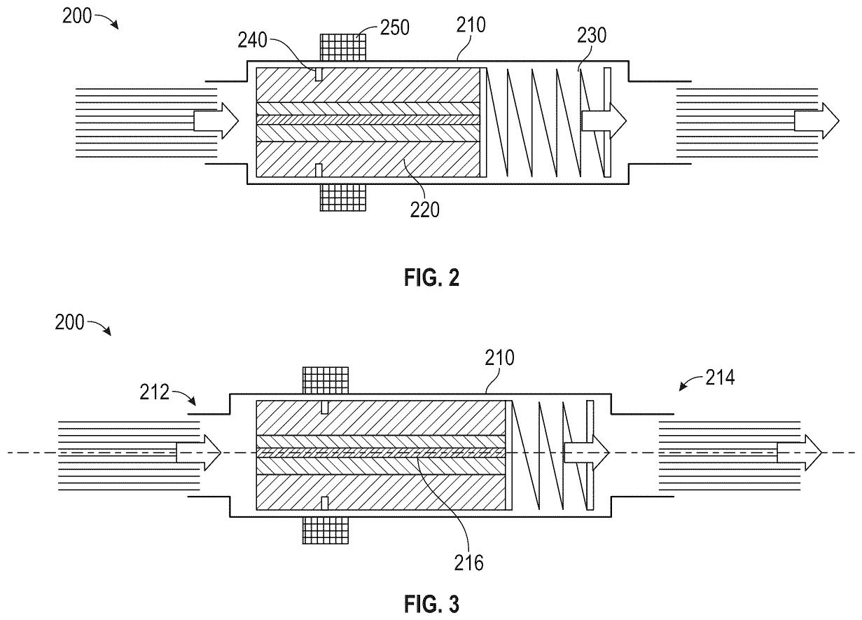

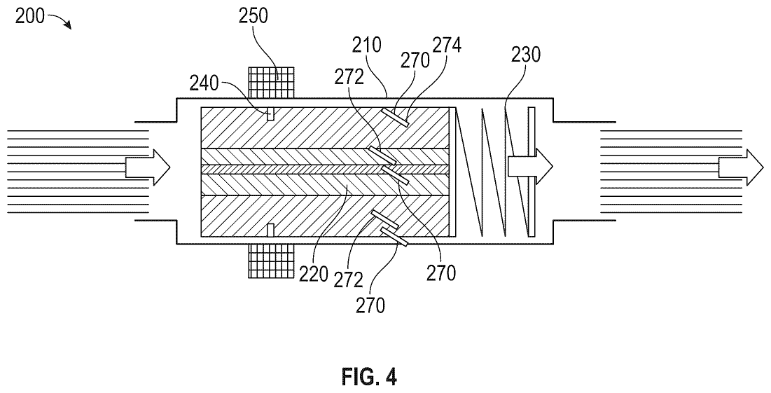

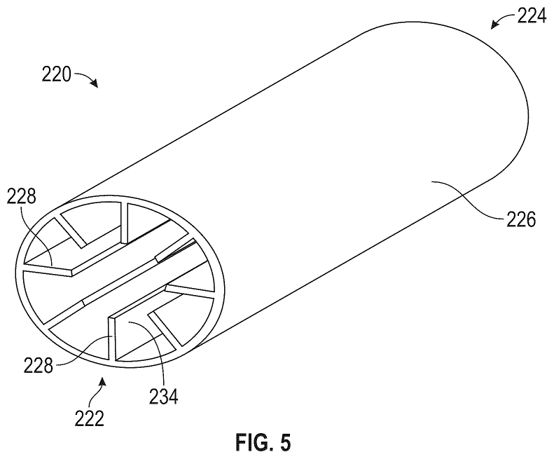

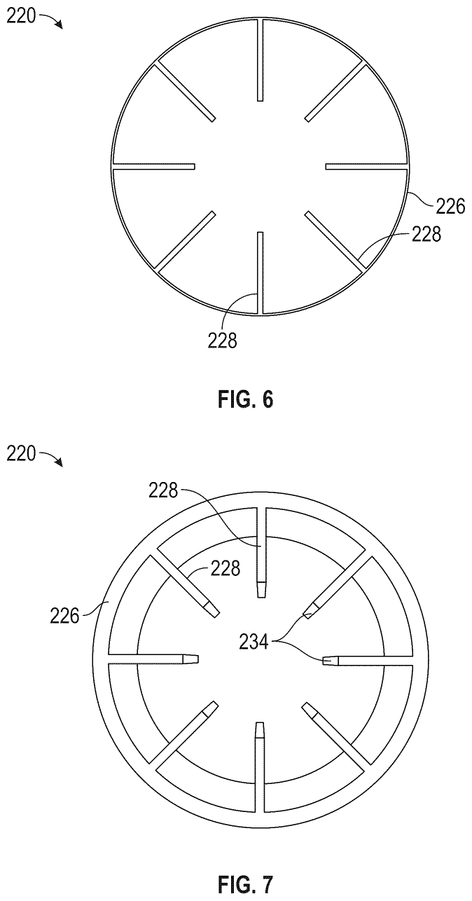

FIG. 1 is a schematic diagram of one of many embodiments of a cooling system according to the disclosure. FIG. 2 is a cross-sectional schematic diagram of one of many embodiments of a flow indicator according to the disclosure, showing a target in one position. FIG. 3 is a cross-sectional schematic diagram of the flow indicator of FIG. 2, showing the target in another position. FIG. 4 is a cross-sectional schematic diagram of another one of many embodiments of a flow indicator according to the disclosure. FIG. 5 is a perspective view of one of many embodiments of a sleeve of a flow indicator according to the disclosure. FIG. 6 is an end view of one of many embodiments of a sleeve of a flow indicator according to the disclosure. FIG. 7 is an end view of another one of many embodiments of a sleeve of a flow indicator according to the disclosure. FIGS. 1-7 are described in conjunction with one another.

In at least one embodiment, a cooling system 100 according to the disclosure can include one or more prime movers 110, such as a compressor or pump, one or more condensers 120, one or more evaporators 130, interconnecting plumbing such as piping 140, one or more flow valves 150, one or more flow indicators 200, or any combination thereof. In at least one embodiment, a cooling fluid, such as a refrigerant, can flow through the piping 140 and extract heat from the evaporator 130, where at least a portion of the fluid changes state, such as from a liquid to a gas. In at least one embodiment, the prime mover 110 can be a compressor that can compress a gaseous portion of the fluid, which can condense in the condenser 120. In at least one embodiment, the prime mover 110 can be a pump and the cooling fluid can be pumped through the piping 140. As the prime mover 110 and/or flow valve 150 begins to fail, the cooling fluid can exhibit insufficient or abnormal flow through the piping 140. In at least one embodiment, the flow indicator 200 can detect and/or report normal and/or abnormal flow of the cooling fluid through the piping 140. In at least one embodiment, the flow indicator 200 can indicate flow through any or all of the piping 140. For example, in a system 100 with multiple prime movers 110, condensers 120, and/or evaporators 130, multiple flow indicators 200 can be used to monitor flow through any or all portions of the piping 140.

In at least one embodiment, a flow indicator 200 according to the disclosure can include one or more housings 210, one or more sleeves 220 disposed within the housing 200, one or more biasing devices 230 configured to bias the sleeve 220 in one or more directions, one or more targets 240 coupled to the sleeve 220, one or more sensors 250 disposed in sensing communication with at least a portion of the sleeve 220, one or more controllers 260 in electrical communication with the sensor 250, or any combination thereof. In at least one embodiment, the controller 260 can monitor the sensor 220, such as to determine the presence of flow, the absence of flow, the amount of flow, or any combination thereof. In at least one embodiment, using the sensor 220, the controller 260 can detect a longitudinal position of the sleeve 220 within the housing 210, rotation of the sleeve 220 within the housing 210, rotational speed of the sleeve 220 within the housing 210, or any combination thereof. In at least one embodiment, the controller 260 can interact with, such as monitor and/or control, and/or can be used to control other components of the system 100, such as the prime mover 110, the condenser 120, the evaporator 130, the piping 140, the flow valve 150, or any combination thereof.

In at least one embodiment, the housing 210 can have an upstream end 212, a downstream end 214, and a longitudinal axis 216. In at least one embodiment, the housing 210 can occupy the same or a similar space as a typical check valve. In at least one embodiment, the housing 210 can be mounted within the piping 140 in the same or similar manner as a typical check valve. In at least one embodiment, the housing 210 can be made of the same material as the piping 140 (e.g., copper or an alloy thereof). In at least one embodiment, the housing 210 can be made of metal and be welded or soldered to the piping 140. In at least one embodiment, the housing 210 can be or include any material sufficient to withstand the operating conditions of the piping 140 and system 100 overall.

In at least one embodiment, the sleeve 220 can freely move laterally and/or rotationally within the housing 210. In at least one embodiment, the sleeve 220 can be three-dimensionally printed, such as in high-temperature polylactic acid (PLA) or another printable material suitable for use in a given implementation of the disclosure. In at least one embodiment, the sleeve 220 can have an upstream end 222 and a downstream end 224. In at least one embodiment, the sleeve 220 can be or include a tubular body 226 and/or can have one or more fins 228 that extend radially inwardly from an interior surface, such as of the tubular body 226. In at least one embodiment, the fins 228 can be aligned with a longitudinal axis of the tubular body 226 or aligned at one or more angles relative thereto, such as to induce rotation of the sleeve 220 during fluid flow. The angles can vary based on the number of the fins 228. In some embodiments, the fins are uniformly spaced apart from each other, or may be irregularly spaced apart from each other. In at least one embodiment, the tubular body 226 can be cylindrical. However, the shape is not limited thereto such that a cross-section of the tubular body 226 may be triangular, rectangular, pentagonal, irregular, etc. In at least one embodiment, at least a portion of the tubular body 226 can be tapered, such as in a direction from one end to another. In at least one embodiment, the interior surface of the tubular body 226 can converge towards a central longitudinal axis of the sleeve 220 in a direction from the upstream end 222 of the sleeve 220 to the downstream end 224 of the sleeve 220. In at least one embodiment, the tubular body 226 can have an outside dimension that increases in a direction from the upstream end 222 of the sleeve 220 to the downstream end 224 of the sleeve 220, such as for centering the sleeve 220 within the housing 210 when fluid is flowing through the flow indicator 200. In at least one embodiment, the tubular body 226 can have a rippled surface, such as on the interior surface and/or the exterior surface thereof, for resisting fluid flow through the flow indicator 220 to position the sleeve 220 within the housing 210.

In at least one embodiment, the biasing device 230 can bias the sleeve 220 towards the upstream end 212 of the housing 210. In at least one embodiment, the sensor 250 can sense the presence and/or absence of the target 240 at one or more sensing positions or locations along the longitudinal axis 216 of the housing 210. In at least one embodiment, by sensing the presence and/or absence of the target 240, the flow indicator 200 can sense the presence and/or absence of flow, or the presence and/or absence of sufficient or normal flow, such as through the prime mover 110 and/or other portions of the system 100.

In at least one embodiment, the biasing device 230 can be or include one or more springs, such as one or more springs disposed longitudinally between the downstream end 224 of the sleeve 220 and a shoulder 218 on the downstream end 214 of the housing 210. For instance, one or more biasing devices 230 may be a compression spring configured to return to the original position when compressed. FIG. 3 shows the biasing device 230 in a compressed position, while FIG. 2 shows the biasing device 230 in an initial position, In at least one embodiment, the sensor 250 can be or include a magnetic proximity sensor. In at least one embodiment, the target 240 can be or include magnetic material. In at least one embodiment, the sensor 250 can detect the target 240 through the housing 210 without a need for any penetration through the housing 210, which can decrease the likelihood of any leaking of the cooling fluid out of the housing 210.

In at least one embodiment, the flow indicator 200 can provide an indication of abnormal flow conditions when the sensor 250 senses the presence, or absence, of the target 240. In at least one embodiment, the flow indicator 200 can provide an indication of flow rate when the sensor 250 senses the presence, or absence, of the target 240, such as by determining how often the sensor 250 senses the presence, or absence, of the target 240. In at least one embodiment, the flow indicator 200 can provide an indication of flow rate by determining where the target 240 is located along the longitudinal axis 216 of the housing 210. As one example, the sleeve 220 can have a default position relative to the housing 210, such as when there is no flow or insufficient flow (see, e.g., FIG. 2). As another example, when there is proper or sufficient flow, the flow can bias the sleeve 220 towards the downstream end 214 of the housing 210, and can at least partially overcome the biasing force of the biasing device 230 (see, e.g., FIG. 3). In at least one embodiment, the flow indicator 200 can be, include, or operate as a switch. For instance, in at least one embodiment, the sensor 250 can trigger an interruption of an electrical circuit when the sensor 250 senses the presence, or absence, of the target 240.

In at least one embodiment, any or all of the fins 228 can be equally spaced about a central longitudinal axis of the sleeve 220. In at least one embodiment, any or all of the fins 228 can be a rectangular prism (see, e.g., FIG. 6). However, that need not be the case and, in at least one embodiment, the fins 228 can be any shape(s) required or desired for an implementation of the disclosure. Similarly, each fin 228 can be of the same shape and/or size, or two or more fins 228 can be of different shapes and/or sizes. In addition, the number of fins 228 can be any number from one, two, three, or more. Any or all of the foregoing variables (among others, such as the length of the sleeve) can vary based on relevant factors such as, for example, the diameter or major dimension of the sleeve 220, fin size, fluid type, flow rate, material type, material finish, signal needs, sensitivity, flow profile, flow meter load, and/or other factors relevant to sensing fluid flow in accordance with an implementation of the disclosure. In at least one embodiment, any or all of the fins 228 can have a radially interior face 234 that bounds a portion of a central flow path through the sleeve 220. In at least one embodiment, the radially interior faces 234 of the fins 228 can be disposed at an angle relative to a central longitudinal axis of the sleeve 220 (see, e.g., FIG. 7). In at least one embodiment, the radially interior faces 234 of the fins 228 can converge towards the central longitudinal axis of the sleeve 220 in a direction from the upstream end 222 of the sleeve 220 to the downstream end 224 of the sleeve 222.

In at least one embodiment, the flow indicator 200 can have one or more ramps 270 disposed within the housing 210 in sliding communication with the one or more fins 228 or portions thereof, which can include one or more corresponding ramps 272. In at least one embodiment, the sleeve 220 can have a default position relative to the one or more ramps 270, such as when there is no fluid flow or abnormal fluid flow through flow indicator 200. In at least one embodiment, the biasing device 230 can bias the sleeve 220 towards the default position with a biasing force. In at least one embodiment, the one or more ramps 270 can cause the sleeve 220 to rotate as the one or more fins 228 and/or ramps 272 slide along the one or more ramps 270 when fluid flow through the flow indicator 200 is sufficient to overcome the biasing force. In at least one embodiment, the one or more ramps 270 can have a downstream terminal end 274. In at least one embodiment, the biasing device 230 can return the sleeve 230 to the default position when the one or more fins 228 and/or ramps 272 reach a slip position. In at least one embodiment, the slip position can be fluidically downstream of the downstream terminal end 274. In at least one embodiment, the ramps 270, 272 can have surface finishes that prevent reverse motion of the sleeve 230 until the ramps 272 reach a slip position relative to the ramps 270.

In at least one embodiment, the sleeve 220 can repeatedly complete a cycle back and forth among the default position and the slip position when a fluid is flowing through the flow indicator 200. In at least one embodiment, the controller 260 can determine a number of the cycles completed and/or a rate at which one or more of the cycles are completed. In at least one embodiment, the sleeve 220 can move in one or more directions within the housing 210 and create an oscillatory action detectable by the sensor 250. In at least one embodiment, the ramps 270, 272 can bias the sleeve 220 towards the biasing device 230. When sufficient fluid flow is present, the force can cause the sleeve 220 to move and load the biasing device 230, which can push the sleeve 220 back when the ramps 270, 272 have passed each other or otherwise reached a return or slip position. In at least one embodiment, such a configuration can provide an indication of a peak flow, such as via a relatively large pulse that, for instance, may not otherwise be captured with the position sensor 250 and can be more easily detectable than positional feedback of less magnitude.

In at least one embodiment, a flow indicator according to the disclosure can include a housing, a sleeve disposed within the housing, a biasing device configured to bias the sleeve, a target coupled to the sleeve, a sensor disposed in sensing communication with at least a portion of the sleeve, or any combination thereof. In at least one embodiment, the housing can have an upstream end, a downstream end, and a longitudinal axis. In at least one embodiment, the sleeve can have an upstream end and a downstream end. In at least one embodiment, the biasing device can bias the sleeve towards the upstream end of the housing. In at least one embodiment, the sensor can sense the presence and/or absence of the target at one or more sensing positions along the longitudinal axis of the housing. In at least one embodiment, by sensing the presence and/or absence of the target, the flow indicator can sense the presence and/or absence of flow, such as through a compressor, pump and/or other portion of a cooling loop.

In at least one embodiment, the biasing device can be or include a spring disposed longitudinally between the downstream end of the sleeve and a shoulder on the downstream end of the housing. In at least one embodiment, the sensor can be or include a magnetic proximity sensor. In at least one embodiment, the target can be or include magnetic material. In at least one embodiment, the flow indicator can provide an indication of abnormal flow conditions when the sensor senses the presence, or absence, of the target. In at least one embodiment, the flow indicator can be, include, or operate as a switch. In at least one embodiment, the sensor can trigger an interruption of an electrical circuit when the sensor senses the presence, or absence, of the target.

In at least one embodiment, the sleeve can be or include a tubular body and/or can have one or more fins that extend radially inwardly from an interior surface, such as of the tubular body. In at least one embodiment, the tubular body can be cylindrical. In at least one embodiment, the tubular body can be tapered. In at least one embodiment, the interior surface of the tubular body can converge towards a central longitudinal axis of the sleeve in a direction from the upstream end of the sleeve to the downstream end of the sleeve. In at least one embodiment, the tubular body can have an outside dimension that increases in a direction from the upstream end of the sleeve to the downstream end of the sleeve for centering the sleeve within the housing when a fluid is flowing through the flow indicator. In at least one embodiment, the tubular body can have a rippled surface configured to resist fluid flow through the flow indicator.

In at least one embodiment, the one or more fins can be or include a plurality of fins, which can be equally spaced about a central longitudinal axis of the sleeve. In at least one embodiment, each of the plurality of fins can be a rectangular prism. In at least one embodiment, each of the plurality of fins can have a radially interior face that bounds a portion of a central flow path through the sleeve. In at least one embodiment, the radially interior face of each of the plurality of fins can be disposed at an angle relative to a central longitudinal axis of the sleeve. In at least one embodiment, the radially interior faces of the plurality of fins can converge towards the central longitudinal axis of the sleeve in a direction from the upstream end of the sleeve to the downstream end of the sleeve.

In at least one embodiment, the flow indicator can have one or more ramps disposed within the housing in sliding communication with the one or more fins. In at least one embodiment, the sleeve can have a default position relative to the one or more ramps. In at least one embodiment, the biasing device can bias the sleeve towards the default position with a biasing force. In at least one embodiment, the one or more ramps can cause the sleeve to rotate as the one or more fins slide along the one or more ramps when fluid flow through the flow indicator is sufficient to overcome the biasing force. In at least one embodiment, the one or more ramps can have a downstream terminal end. In at least one embodiment, the biasing device can return the sleeve to the default position when the one or more fins reach a slip position fluidically downstream of the downstream terminal end. In at least one embodiment, the sleeve can repeatedly complete a cycle back and forth among the default position and the slip position when a fluid is flowing through the flow indicator. In at least one embodiment, the flow indicator can include a controller in electrical communication with the sensor. In at least one embodiment, the controller can determine a number of the cycles completed and/or a rate at which one or more of the cycles are completed.

Other and further embodiments utilizing one or more aspects of the disclosure can be devised without departing from the spirit of Applicant's disclosure. For example, the devices, systems and methods can be implemented for numerous different types and sizes in numerous different industries. Further, the various methods and embodiments of the devices, systems and methods can be included in combination with each other to produce variations of the disclosed methods and embodiments. Discussion of singular elements can include plural elements and vice versa. The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the inventions has been described. Obvious modifications and alterations to the described embodiments are available to those of ordinary skill in the art having the benefits of the present disclosure. The disclosed and undisclosed embodiments are not intended to limit or restrict the scope or applicability of the inventions conceived of by the Applicant, but rather, in conformity with the patent laws, Applicant intends to fully protect all such modifications and improvements that come within the scope or range of equivalents of the following claims.

What is claimed is:

1. A flow indicator, comprising:
a housing having an upstream end, a downstream end, and a longitudinal axis;
a sleeve disposed within the housing and having an upstream end and a downstream end;
a biasing device configured to bias the sleeve towards the upstream end of the housing;
a target coupled to the sleeve; and
a sensor disposed in sensing communication with at least a portion of the sleeve;
wherein the sensor is configured to sense at least one of the presence or absence of the target at one or more sensing positions along the longitudinal axis of the housing.

2. The flow indicator of claim 1, wherein the sleeve comprises a tubular body and one or more fins that extend radially inwardly from an interior surface of the tubular body.

3. The flow indicator of claim 2, wherein the one or more fins comprise a plurality of fins equally spaced about a central longitudinal axis of the sleeve.

4. The flow indicator of claim 2, wherein the one or more fins comprise a plurality of fins, and wherein each of the plurality of fins is a rectangular prism.

5. The flow indicator of claim 2, wherein the one or more fins comprise a plurality of fins, and wherein each of the plurality of fins has a radially interior face that bounds a portion of a central flow path through the sleeve.

6. The flow indicator of claim 5, wherein the radially interior face of each of the plurality of fins is disposed at an angle relative to a central longitudinal axis of the sleeve.

7. The flow indicator of claim 6, wherein the radially interior faces of the plurality of fins converge towards the central longitudinal axis of the sleeve in a direction from the upstream end of the sleeve to the downstream end of the sleeve.

8. The flow indicator of claim 2, wherein the tubular body is cylindrical.

9. The flow indicator of claim 2, wherein the interior surface of the tubular body converges towards a central longitudinal axis of the sleeve in a direction from the upstream end of the sleeve to the downstream end of the sleeve.

10. The flow indicator of claim 2, wherein the tubular body is tapered and has an outside dimension that increases in a direction from the upstream end of the sleeve to the downstream end of the sleeve for centering the sleeve within the housing when a fluid is flowing through the flow indicator.

11. The flow indicator of claim 2, wherein the tubular body has a rippled surface configured to resist fluid flow through the flow indicator.

12. The flow indicator of claim 1, wherein the biasing device comprises a spring disposed longitudinally between the downstream end of the sleeve and a shoulder on the downstream end of the housing.

13. The flow indicator of claim 1, wherein the flow indicator is configured to provide an indication of abnormal flow conditions when the sensor senses the presence of the target.

14. The flow indicator of claim 1, wherein the flow indicator is configured to provide an indication of abnormal flow conditions when the sensor senses the absence of the target.

15. The flow indicator of claim 1, wherein the sensor is a magnetic proximity sensor and the target comprises magnetic material.

16. The flow indicator of claim 1, wherein the flow indicator is a switch and wherein the sensor is configured to trigger an interruption of an electrical circuit when the sensor senses at least one of the presence or the absence of the target.

17. The flow indicator of claim 2, further comprising:
one or more ramps disposed within the housing in sliding communication with the one or more fins;
wherein the sleeve has a default position relative to the one or more ramps;
wherein the biasing device is configured to bias the sleeve towards the default position with a biasing force; and
wherein the one or more ramps are configured to cause the sleeve to rotate as the one or more fins slide along the one or more ramps when fluid flow through the flow indicator is sufficient to overcome the biasing force.

18. The flow indicator of claim 17, wherein the one or more ramps have a downstream terminal end, and wherein the biasing device is configured to return the sleeve to the default position when the one or more fins reach a slip position fluidically downstream of the downstream terminal end.

19. The flow indicator of claim 18, wherein the sleeve is configured to repeatedly complete a cycle back and forth among the default position and the slip position when a fluid is flowing through the flow indicator.

20. The flow indicator of claim 19, further comprising a controller in electrical communication with the sensor, wherein the controller is configured to determine at least one of: a number of the cycles completed, a rate at which one or more of the cycles are completed, and a combination thereof.
